(19) United States
(12) Patent Application Publication
(10) Pub. No.: US 2007/0276651 A1
(43) Pub. Date: Nov. 29, 2007

(54) GRAMMAR ADAPTATION THROUGH COOPERATIVE CLIENT AND SERVER BASED SPEECH RECOGNITION

(75) Inventors: Harry M. Bliss, Evanston, IL (US); W. Garland Phillips, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/419,804

(22) Filed: May 23, 2006

(51) Int. Cl. G06F 17/27

(52) U.S. Cl. 704/9

(57) ABSTRACT

A system (200) and method (300) for grammar adaptation is provided. The method can include attempting a first recognition of a spoken utterance (304) using a first speech grammar (204), consulting (308) a second speech grammar (224) based on a recognition failure, and receiving a correct recognition result (310) and a portion of a speech grammar for updating (312) the first speech grammar. The first speech grammar can be incrementally updated, or expanded, to broaden grammar coverage for adapting to a user's vocabulary and grammar over time.

### FIELD OF THE INVENTION

The embodiments herein relate generally to speech recognition and more particularly to speech recognition grammars.

### BACKGROUND

The use of portable electronic devices and mobile communication devices has increased dramatically in recent years. Mobile communication devices are offering more features such as speech recognition, pictures, music, audio, and video. Such features are facilitating the ease by which humans can interact with mobile devices. Also, the speech communication interface between humans and mobile devices becomes more natural as the mobile devices attempt to learn from their environment and the people within the environment using the portable devices. Many speech recognition features available on a mobile communication device can require access to large databases of information. These databases can include phonebooks and media content which can exist external to the mobile device. The databases can exist on a network which the mobile device can access to receive this information.

Techniques for accomplishing automatic speech recognition (ASR) are well known in the art. Among known ASR techniques are those that use grammars. A grammar is a representation of the language or phrases expected to be used or spoken in a given context. In one sense, then, ASR grammars typically constrain the speech recognizer to a vocabulary that is a subset of the universe of potentially-spoken words; and grammars may include sub-grammars. ASR grammar rules, from one or more grammars or sub-grammars, can then be used to represent the set of “phrases” or ordered combinations of words that may be expected in a given context. “Grammar” may also refer generally to a statistical language model (where a statistical language model can represent phrases and transition probabilities between words in those phrases), such as those used in a dictation speech recognizer.

Speech recognition systems on mobile devices are capable of adequately recognizing human speech though they are limited by the size of vocabularies and the constraints set forth by grammars. The speech recognition systems can associate complex spoken utterances with specific actions using speech grammar rules. The device-based speech recognition systems have an advantage of low latency and not requiring a network connection. However, a portable device has limited resources including smaller vocabularies and less extensive speech grammars. Accordingly, large vocabulary and extensive speech grammars for multiple contexts can be impractical on power-limited and memory-limited portable devices. In contrast, a network speech recognition system can work with very large vocabularies and grammars for many contexts, and can provide higher recognition accuracy.

Also, a user of a mobile device is generally the person most often using the speech recognition capabilities of the mobile device. The speech recognition system can employ speech grammars to narrow the field of search which in turn assists the speech recognition system to derive the correct recognition. However, the speech grammar does not generally incorporate speech recognition performance and thus is not generally informed with regard to successful or failed recognition attempts. A need therefore exists for improving speech recognition performance by considering the contribution of the speech grammar to the speech recognition process.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a diagram of a mobile communication environment;

FIG. 2 is a schematic showing speech processing components of a mobile device in accordance with the embodiments of the invention;

FIG. 3 is a flowchart of grammar adaptation in accordance with the embodiments of the invention;

FIG. 4 is a method of grammar adaptation in accordance with the embodiments of the invention;

FIG. 5 is an example of a grammar adaptation suitable for use in a cell phone in accordance with the embodiments of the invention;

FIG. 6 is an example of a grammar adaptation suitable for use in a portable music player in accordance with the embodiments of the invention;

FIG. 7 is a method of adapting a speech grammar for voice dictation in accordance with the embodiments of the invention; and

FIG. 8 is an example of a grammar adaptation suitable for use in voice dictation in accordance with the embodiments of the invention; and

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The embodiments of the invention concern a method and system for updating one or more speech grammars based on a speech recognition performance. For example, a mobile device having a device-based speech recognition system and a speech grammar can enlist a server having a speech recognition system and a speech grammar for achieving higher recognition accuracy. The speech grammar on the mobile device can be updated with the speech grammar on the server in accordance with a speech recognition failure. For example, the speech grammar on the mobile device can be evaluated for a recognition performance of a spoken utterance. Upon a recognition failure, the speech grammar on the server can be evaluated for correctly identifying the spoken utterance. The server can send one or more portions of the speech grammar used to correctly identify the spoken utterance to the mobile device. The portions of the speech grammar can provide one or more correct interpretations of the spoken utterance. The portions can also include data corresponding to the correct recognition, such as phonebook contact information or music selection data. The speech grammar on the mobile device can be incrementally updated, or expanded, to broaden grammar coverage for adapting to a user's vocabulary and grammar over time.

The method includes selecting a first speech grammar for use in a first speech recognition system, attempting a first recognition of a spoken utterance using the first speech grammar, consulting a second speech recognition system using a second speech grammar based on a recognition failure of the first grammar, and sending the correct recognition having corresponding data and a portion of the second speech grammar to the first speech recognition system for updating the recognition and the first speech grammar. The first speech recognition system adapts the recognition of the spoken utterance and the first speech grammar in view of the correct recognition and second speech grammar provided by the second recognition system. Notably, the speech grammar is a set of rules for narrowing a recognition field of a spoken utterance which is updated based on a recognition performance. The method includes synchronizing the first speech grammar with the second speech grammar for providing a context of the spoken utterance.

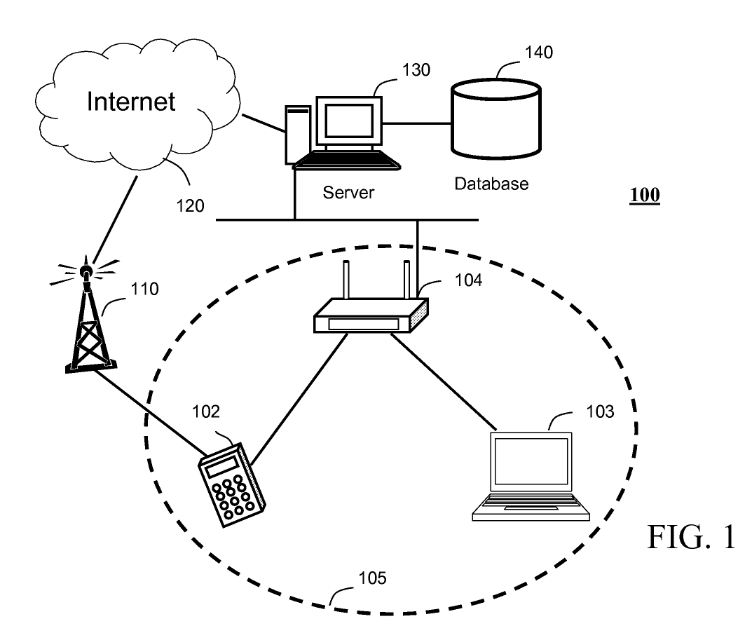

Referring to FIG. 1, a mobile communication environment 100 for speech recognition is shown. The mobile communication environment 100 can provide wireless connectivity over a radio frequency (RF) communication network or a Wireless Local Area Network (WLAN). In one arrangement, the mobile device 102 can communicate with a base receiver 110 using a standard communication protocol such as CDMA, GSM, or iDEN. The base receiver 110, in turn, can connect the mobile device 102 to the Internet 120 over a packet switched link. The internet 120 can support application services and service layers for providing media or content to the mobile device 102. The mobile device 102 can also connect to other communication devices through the Internet 120 using a wireless communication channel. The mobile device 102 can establish connections with a server 130 on the network and with other mobile devices for exchanging information. The server 130 can have access to a database 140 that is stored locally or remotely and which can contain profile data. The server can also host application services directly, or over the internet 120. In one arrangement, the server 130 can be an information server for entering and retrieving presence data.

The mobile device 102 can also connect to the Internet over a WLAN 104. Wireless Local Access Networks (WLANs) provide wireless access to the mobile communication environment 100 within a local geographical area 105. WLANs can also complement loading on a cellular system, so as to increase capacity. WLANs are typically composed of a cluster of Access Points (APs) 104 also known as base stations. The mobile communication device 102 can communicate with other WLAN stations such as a laptop 103 within the base station area 105. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 102 can send and receive data to the server 130 or other remote servers on the mobile communication environment 100. In one example, the mobile device 102 can send and receive grammars and vocabularies from a speech recognition database 140 through the server 130.

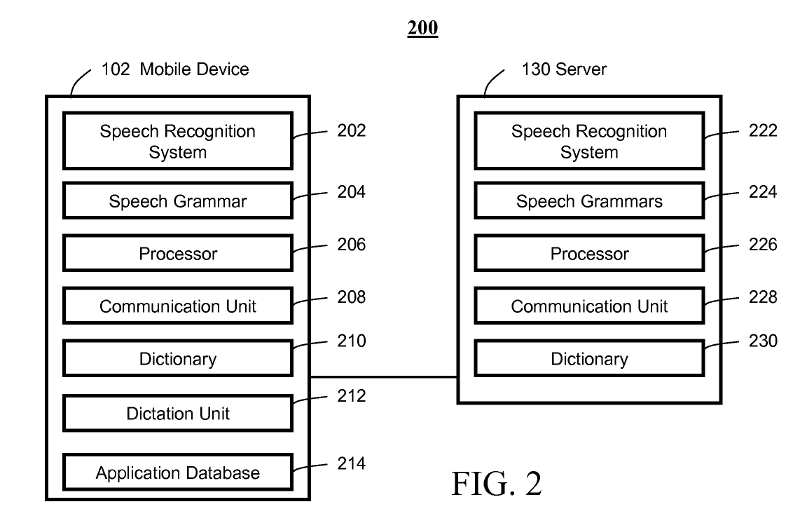

Referring to FIG. 2, components of the mobile device 102 and the server 130 in accordance with the embodiments of the invention are shown. The mobile device 102 can be any type of communication device such as a cell phone, a personal digital assistant, a laptop, a notebook, a media player, a music player, a radio, or the like. The mobile device 102 can include a speech recognition system (SRS) 202 having a local vocabulary, a speech grammar 204, and a processor 206. The processor 206 can be a microprocessor, a DSP, a microchip, or any other system or device capable of computational processing. The mobile device 102 can include peripheral input and output components such as a microphone and speaker known in the art for capturing voice and playing speech and/or music. The mobile device 102 can also include a dictionary 210 for storing a vocabulary association, a dictation unit 212 for recording voice, and an application database 214 to support applications. The dictionary can include one or more words having a pronunciation transcription, and having other associated speech recognition resources including word meaning. The SRS 202 can refer to the dictionary 210 for recognizing one or more words of the SRS 202 vocabulary. The application database 214 can contain phone numbers for phone book applications, songs for a music browser application, or another form of data required for a particular application on the Mobile Device 102.

The SRS 202 can receive spoken utterances from a user of the mobile device and attempt to recognize certain words or phrases. Those skilled in the art can appreciate that the SRS 202 can also be applied to voice navigation, voice commands, VoIP, Voice XML, Voice Identification, Voice dictation, and the like. The SRS 202 can access the speech grammar 204 which provides a set of rules to narrow a field of search for the spoken utterance in the local vocabulary. The mobile device 102 can also include a communication unit 208 for establishing a communication channel with the server 130 for sending and receiving information. The communication unit can be an RF unit which can provide support for higher layer protocols such as TCP/IP and SIP on which languages such as Voice Extensible Markup Language (VoiceXML) can operate. The processor 206 can send the spoken utterance to the server 130 over the established communication channel. Understandably, the processor 206 can implement functional aspects of the SRS 202, the speech grammar 204, and the communication unit 208. These components are shown separately only for illustrating the principles of operation, which can be combined within other embodiments of the invention herein contemplated.

The server 130 can also include a speech recognition system (SRS) 222, one or more speech grammars 224, a communication unit 228, and a processor 226. The communication unit 228 can communicate with the speech recognition database 140, the internet 120, the base receiver 110, the mobile device 102, the access point 104, and other communication systems connected to the server 130. Accordingly, the server 130 can have access to extensive vocabularies, dictionaries, and numerous speech grammars on the internet. For example, the server 130 can download large speech grammars and vocabularies from the mobile communication environment 100 to the speech grammars 224 and the dictionary 230, respectively. Understandably, the server 130 has access to the mobile communication environment 100 for retrieving extensive vocabularies and speech grammars that may be too large in memory to store on the mobile device 102.

Understandably, the mobile device 102 can be limited in memory and computational complexity which can affect response time and speech recognition performance. As is known in the art, smaller devices having smaller electronic components are typically power constrained. This limits the extent of processing they can perform. In particular, speech recognition processes consume vast amounts of memory and processing functionality. The mobile device 102 is governed by these processing limitations which can limit the successful recognition rate. However, the speech recognition system 202 on the mobile device 102 has an advantage of low-latency and not requiring a network connection. In contrast, the speech recognition system 222 on the server 130 can work with very large grammars that can be easily updated. The server 130 can access network connectivity to vast resources including various speech grammars, dictionaries, media, and language models.

In practice, a user of the mobile device 102 can speak into the mobile device 102 for performing an action, for example, voice dialing, or another type of command and control response. The SRS 202 can recognize certain spoken utterances that may be licensed by the SRS 202 speech grammar 204, and dictionary 210. In one aspect, the speech grammar 204 can include symbolic sequences for identifying spoken utterances and associating the spoken utterances with an action or process. For example, for voice command dialing, the speech grammar 204 can include an association of a name with a phone number dial action or other actions corresponding to a recognized spoken name. For example, the spoken utterance “Lookup Robert” may be represented in the grammar to access an associated phone number, address, and personal account from the application database 214.

The SRS 202 may require advance knowledge of the spoken utterances that it will be asked to listen for. Accordingly, the SRS 202 references the speech grammar 204 for this information which provides the application context. The speech grammar identifies a type of word use and the rules for combining the words specific to an application. For example, a grammar for ordering from a food menu would contain a list of words on the menu and an allowable set of rules for combining the words. General words can be identified by the first SRS 202 and more specific words can be identified by the second SRS 222. The first SRS 202 and the second SRS 222 can use grammars of the same semantic type to establish the application context. This advance notice may come in the form of a grammar file that describes the rules and content of the grammar. For example, the grammar file can be a text file which includes word associations in Backus-Naur-Form (BNF). The grammar file defines the set of rules that govern the valid utterances in the grammar. As an example, a grammar for the reply to the question: “what do you want on your pizza?” might be represented as:

<reply>: ((“I want” | “I'd like”)(“mushrooms” | “onions”));

Under this set of rules, all valid replies consists of two parts: 1) either “I want” or “I'd like”, followed by 2) either “mushrooms” or “onions”. This notation is referred to as Backus-Naur-Form (BNF), where adjacent elements are logically AND'd together, and the ‘|’ represents a logical OR. The rules are a portion of the speech grammar that can be added to a second speech grammar to expand a grammar coverage for the second speech grammar. The grammar file can be created by a developer of an application on the mobile device 102 or the server 130. The grammar file can be updated to include new rules and new words. For example, the SRS 202 accesses the dictionary 210 for recognizing spoken words and correlates the results with the vocabulary of the speech grammar 204. It should be noted that a grammar rule can be augmented with a semantic annotation to represent an action taken by the device that is associated with words patterns licensed by that rule. For example, within a food menu ordering application, a user can request a menu order, and the device upon recognizing the request, can submit the order.

In general, the user of the mobile device 102 is the person most often employing the speech recognition capabilities of the device. For example, the user can have an address book or contact list stored in the application database 214 of the mobile device 102 which the user can refer to for initiating a telephone call. The user can submit a spoken utterance which the SRS 202 can recognize to initiate a telephone call or perform a responsive action. During the call, the user may establish a dialogue with a person in a predetermined manner which includes a certain speech grammar. For example, whereas the user may speak to their co-worker using a certain terminology or grammar, the user may speak to their children with another terminology and grammar. Understandably, the grammar narrows the field of search for recognizing spoken utterances in a certain application context. That is, the grammar is capable of indicating a most likely sequence of words in a context by giving predictive weight to certain words based on a predetermined arrangement.

The application context, and accordingly, the speech grammars can differ for human to device dialogue systems. For example, during a call a user may speak to a natural language understanding system in a predetermined manner. Various speech grammars can exist for providing dialog with phone dialing applications, phone book applications, and music browser applications. For instance, a user may desire to play a certain song on the mobile device. The user can submit a spoken utterance presenting the song request for selecting a downloadable song. The SRS 202 can recognize the spoken utterance and accesses the dictionary 210 to correlate the recognition with the song list vocabulary of the corresponding speech grammar 204. Each application can have its own speech grammar which can be invoked when the user is within the application. For example, when the user is downloading a song, a song list grammar can be selected. As another example, when the user is scrolling through a phonebook entry, a phonebook grammar can be selected.

However, a default speech grammar may not be generally applicable to such a wide range of grammar contexts; that is, recognizing various words in different speaking situations for different spoken dialog applications. In these situations, the default speech grammar may not be capable of applying generalizations for recognizing the spoken utterances. For example, the SRS 202 may fail to recognize a spoken utterance due to inadequate grammar coverage. The speech recognition may not successfully recognize a spoken utterance because the speech grammar has limited interpretation abilities in the context of an unknown situation. That is, the grammar file may not provide sufficient rules or content for adequately providing grammar coverage.

Accordingly, embodiments of the invention provide for updates to one or more speech grammars that can be applied for different application contexts. Moreover, the speech grammar can be updated based on failed recognition attempts to recognize utterances specific to a user's common dialogue. In practice, a mobile device can adapt a grammar to the dialogue of the user for a given situation, or application. The speech grammar which can be particular to the user can be portable across devices. For example, the speech grammar, or portions of the speech grammar, can be downloaded to a device the user is operating.

In certain situations, the mobile device 102 can refer to the server 130 for retrieving out-of-vocabulary, or unrecognized words. For example, the user may present a spoken utterance which the local speech recognition system 202 cannot recognize. In response, the mobile device 102 can send the spoken utterance or a portion of the spoken utterance to the server for recognizing the spoken utterance, identifying one or more resources associated with the utterance, and identifying a portion of a speech grammar used for recognizing the spoken utterance. The server 130 can send the recognition, which can be a word sequence, with the vocabulary of the recognition, the portion of the speech grammar and the associated resources to the mobile device 102. The mobile device 102 can use the portions of the speech grammar to update the local speech grammar. The vocabulary can include one or more dictionary entries which can be added to the dictionary 210. Notably, the recognition can also include a logical form representing the meaning of the spoken utterance. Also, the associated resources, which can be phone numbers, addresses, or music selections, or the like, can be added to the application database 214.

Consider that the mobile device 102 may not always have connectivity in the mobile communication environment of FIG. 1. Accordingly, the mobile device 102 may not always be able to rely on the server's speech recognition. Understandably, the mobile device 102 can refer to the updated speech grammar which was downloaded in response to a previous recognition failure. The speech grammar can be adapted to the vocabulary and grammar of the user which is one advantage of the invention.

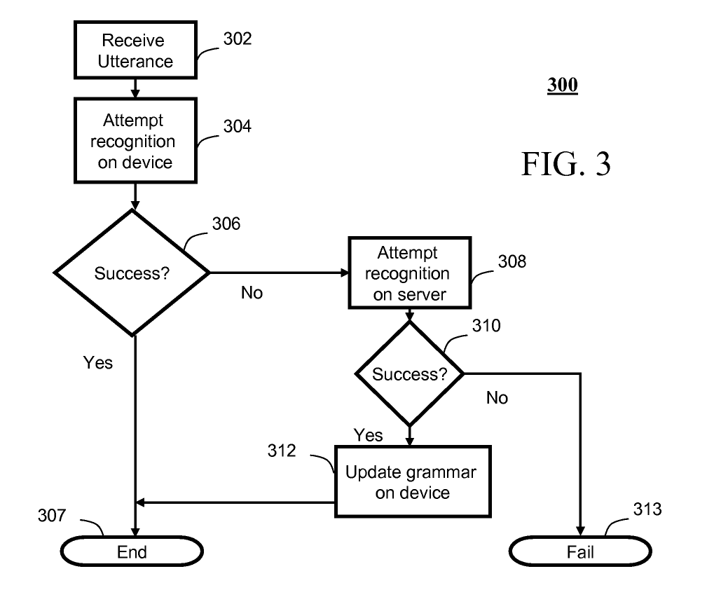

Referring to FIG. 3, a high level flowchart 300 of grammar adaptation is shown in accordance with the embodiments of the invention. The flowchart 300 describes a sequence of events for updating a speech grammar on a mobile device from a speech grammar on a server. In particular, portions of the speech grammar on the server are sent to the mobile device for updating the speech grammar on the mobile device. This can include vocabularies having one or more word dictionary entries. At step 302, a spoken utterance can be received on the mobile device 102. At step 304, the SRS 202 on the mobile device can attempt a recognition of the spoken utterance. The SRS 202 can reference the speech grammar 204 for narrowing a recognition search of the spoken utterance. For example, the SRS 202 may reference the dictionary 210 to identify one or more words in the SRS 202 vocabulary corresponding to the spoken utterance. However, the SRS 202 may not identify a suitable recognition or interpretation of the spoken utterance due to the speech grammar. For example, a word corresponding to the spoken utterance may be in the dictionary 210 though the SRS 202 did not identify the word as a potential recognition match. Notably, the speech grammar identifies a list of potential word patterns for being recognized. Accordingly, the SRS 202 may return a recognition failure even though the word is available. The SRS 202 will also return a recognition failure if the word is not in the vocabulary. It should be noted that there can be many other causes for failure, and this is just one example not herein limiting the invention.

At step 306, the mobile device 102 can determine if the recognition 304 was successful. In particular, if the SRS 202 is not successful, the speech grammar may be inadequate. Upon, identifying an unsuccessful speech recognition, the mobile device 102 sends the spoken utterance to the server 130. At step 308, the server 130 attempts a recognition of the spoken utterance. The server can reference one or more connected systems in the mobile communication environment 100 for recognizing the spoken utterance. At step 310, a success of the SRS on the server can be evaluated. If the server cannot recognize the spoken utterance, an unsuccessful recognition 313 is acknowledged, and an unsuccessful recognition response can be provided to the mobile device. If the server successfully recognizes the spoken utterance, the correct recognition and a portion of the speech grammar used for recognizing the spoken utterance can be sent to the mobile device. At step 312, the mobile device can update the local speech grammar with the portion of the speech grammar received from the server. Notably, aspects of the invention include sending at least a portion of the speech grammar used for recognizing the spoken utterance. The portion can include the entire speech grammar. Understandably, the local speech grammar is updated for adapting the speech recognition system on the device to provide grammatical coverage. Notably, a portion of a dictionary associated with the portion of the grammar and a portion of an application database associated with the portion of the grammar can be sent to the mobile device along with the portion of a grammar.

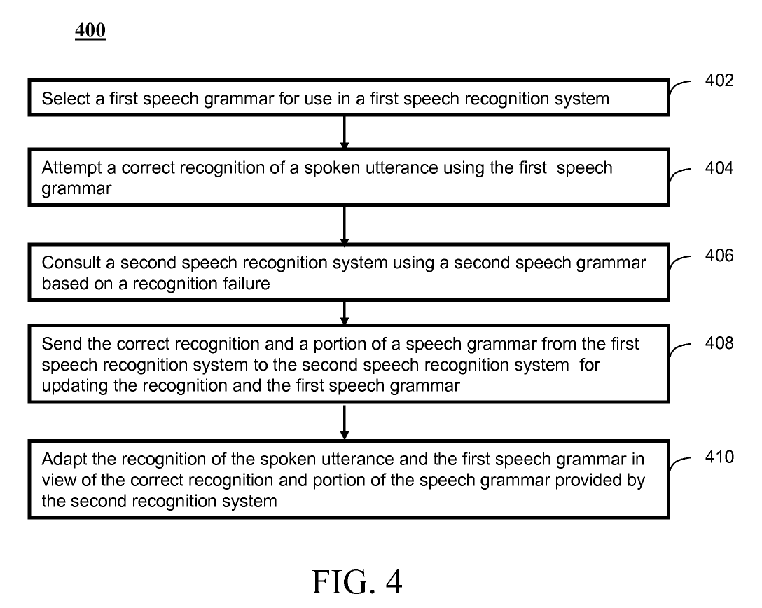

Referring to FIG. 4, a method 400 for grammar adaptation is provided. The steps of method 400 further clarify the aspects of the flowchart 300. Reference will be made to FIG. 1 for identifying the components associated with the processing steps. At step 402, a first speech grammar can be selected for use with a first speech recognition system. For example, a user can submit a spoken utterance which can be processed by the SRS 202 (302). The SRS 202 can select one or more speech grammars 204 to evaluate the spoken utterance and attempt a correct recognition at step 404 using the selected speech grammar (304). Based on an unsuccessful recognition (306), the mobile device 102 can consult a second SRS 222 on the server 130 at step 406. For example, the communication unit 208 and the processor 206 can send the spoken utterance to the communication unit 228 on the server 130 for recognizing the spoken utterance (308).

The processor can also synchronize speech grammar 204 with the second speech grammar 224 for improving a recognition accuracy of the second SRS 222. Understandably, the second SRS 222 may not be aware of the context of the first SRS 202. That is, the second SRS 222 may perform an exhaustive search for recognizing a word that may not apply to the situation (i.e. the context). The synchronization of the second speech grammar 224 with the speech grammar 204 beneficially reduces the search scope for the second SRS 22. By synchronizing the speech grammar between the first SRS 202 and second SRS 222, the second SRS 222 can reduce the scope to search for the correct speech recognition match. For example, if the first SRS 202 is using a speech grammar 204 and searching for a food menu item in a food ordering list which it cannot recognize, the mobile device 102 can send the unrecognized food menu item and synchronize the second speech grammar 224 with the first speech grammar 204. Accordingly, the SRS 222 can search for the unrecognized food menu item based on a context established by the synchronized speech grammar 224. For example, the SRS 222 will not search for automotive parts in an automotive ordering list if the speech grammar 224 identifies the grammar as a food menu order. The synchronization reduces the possible words that match the speech grammar associated with the food menu ordering

The first speech recognition system and the second speech recognition system can use grammars of the same semantic type for establishing the application context. The semantics of the grammar can define the meaning of the terms used in the grammar. For example, a food menu ordering application may have a food selection related speech grammar, whereas a hospital application may have a medical history speech grammar. A weather application may have an inquiry section for querying weather conditions or statistics. Another context may include location-awareness wherein a user speaks a geographical area for acquiring location-awareness coverage, such as presence information. The SRS 224 on the server 130 can download speech grammars and vocabularies for recognizing the received spoken utterance. If the SRS 224 correctly identifies the spoken utterance (310), the server 130 can send the correct recognition with a portion of the speech grammar to the mobile device 102 (312). The recognition may include a correct interpretation of the spoken utterance along with associated resources such as phone numbers, addresses, music selections and the like. The recognition can also include dictionary entries for the correct vocabulary and a list of nearest neighbor recognitions. For example, a nearest neighbor can be one or more words having a correct interpretation of the spoken utterance, such as a synonym.

The server 130 can also update a resource such as the speech grammar 224 based on a receipt of the correct recognition from the mobile device 102. The resource can also be a dictionary, a dictation memory, or a personal information folder such as a calendar or address book though is not limited to these. The server 130 can also add the correct vocabulary and the list of nearest neighbor recognitions to a dictionary 230 associated with the user of the mobile device. In another aspect, the mobile device can send a receipt to the server 130 upon receiving the vocabulary and verifying that it is correct. The server can store a profile of the correct recognitions in the dictionary 230 including the list of nearest neighbor recognitions provided to the mobile device 102. The dictionary can include a list of pronunciations.

Upon receiving the correct recognition, the mobile device 102 can update the dictionary 210 and the speech grammar 204 (312). For example, for a dictation style speech recognition, the portion of the speech grammar may be a language model such as an N-gram. The correct recognition can include new vocabulary words, new dictionary entries, or a new resource associated with the correct recognition such as a phone number, address, or music selection. In the case of a command and control style speech recognition, a set of constrained commands can be recognized using a finite state grammar or other language constraint such as a context free grammar or a recursive transition network. A finite state grammar is a graph of allowable word transitions, a context free grammar is a set of rules of a particular context free grammar rule format, and a recursive transition network is a collection of finite state grammars which can be nested.

At step 410, the speech grammar 204 can be adapted in view of the correct vocabulary and the provided portion of the speech grammar. For example, the speech grammar 204 word connections can be adjusted to incorporate new word connections, or the dictionary 210 can be updated with the vocabulary. The mobile device can also log one or more recognition successes and one or more recognition failures for tuning the SRS 202.

If the SRS 222 is incapable of recognizing the spoken utterance, a recognition failure can be sent to the mobile unit 102 to inform the mobile unit 102 of the failed attempt. In response, the mobile unit 102 can display an unsuccessful recognition message to the user and request the user to submit a correct recognition. For example, the user can type in the unrecognized spoken utterance. The mobile device receives the manual text entry and updates the SRS 202 and speech grammar 204 in accordance with the new vocabulary information. The dictionary 210 can be updated with the vocabulary of the text entry using a letter to sound program to determine the pronunciations of the new vocabulary.

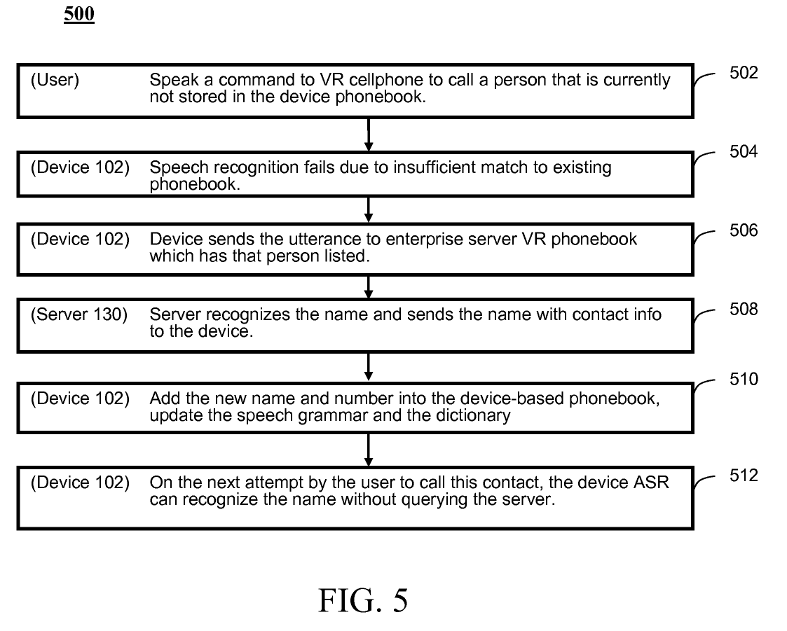

Referring to FIG. 5, an example of a grammar adaptation for a cell phone is shown. For example, the mobile device 102 can include a phone book (214) for identifying one or more call parameters. At step, 502, a user speaks a command to Voice Recognition (VR) cell-phone (102) to call a person that is currently not stored in the device phonebook (214). The speech recognition (202) may fail due to insufficient match to existing speech grammar (204), or dictionary (210). In response, the device (102) sends the utterance to the server (130) which has that person listed in a VR phonebook. In one arrangement, the server 130 can be an enterprise server. The server (130) recognizes the name and sends the name with contact info, dictionary entries (230), and a portion of the speech grammar (224) to the device. The device (102) adds the new name and number into the device-based phonebook (214) and updates the speech grammar (204) and dictionary (210). On the next attempt by the user to call this contact, the device (102) SRS will be able to recognize the name without accessing the server.

In one scenario, the phonebook may be filled, and the least frequently used entry can be replaced on the next recognition failure update. For example, the SRS 202 can update the speech grammar (204) and dictionary (210) with the correct recognition, or vocabulary words, received from the server (130). The mobile device can also evaluate a usage history of vocabularies in the dictionary, and replace a least frequently used vocabulary with the correct recognition. In another scenario, the user may know a particular entry is not on the device and explicitly requests the device (102) to download the entry. The entry can include a group list or a class list. For example, the user can request a class of entries such as “employees in Phoenix” to be uploaded. If the entry does not exist on the server (130), the user can manually enter the entry and associated information using a multimodal user interface wherein the server is also updated.

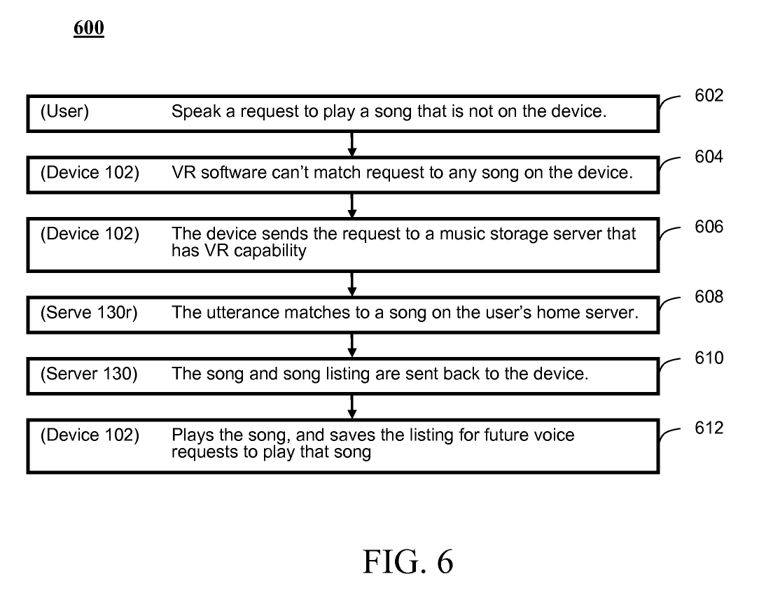

Referring to FIG. 6, another example of a grammar adaptation for a portable music player is shown. For example, the mobile device 102 can be a music player for playing one or more songs from a song list and updating the speech grammar with the song list, wherein a spoken utterance identifies a song. At step 602, a user speaks a request to play a song that is not on the device (102). The VR software (202) cannot match a request to any song on the device. The device (102) sends the request to a music storage server (130) that has VR capability (222). The server (130) matches the request to a song on the user's home server. For example, the mobile device (102) can request the server (130) to provide seamless connection with other devices authorized by the user. For instance, the user allows the server (130) to communicate with the user's home computer to retrieve files or information including songs. Continuing with the example, the server (130) sends the song name portion of a grammar and song back to the device (102). The device (102) plays the song, and saves the song in a song list for future voice requests to play that song. Alternatively, the song may already be available on the mobile device, though the SRS 202 was incapable of recognizing the song. Accordingly, the server 130 can be queried with the failed recognition to interpret the spoken utterance and identify the song. The song can then be accessed from the mobile device.

In one arrangement, the songs remain on the server (130) and playback is streamed to the device (102). For example, downloading the song may require a prohibitive amount of memory and processing time. In addition, costs may be incurred for the connections service that would deter the user from downloading the song in its entirety. The user may prefer to only hear a portion, or clip, of the song at a reduced cost. Accordingly, the song can be streamed to the user thereby allowing the user to terminate the streaming; that is, the delivery of content ceases upon a user command. In this arrangement the song list can be downloaded to the device. The user can speak the name of the song which the audio content of the song will be streamed to the device. The server (130) can be consulted for any failures in recognizing the spoken utterance.

In one example, the mobile device 102 broadcasts the song request to all of the user's network accessible music storage having VR capability. For example, the user can have multiple devices interconnected amongst one another within the mobile communication environment 100 and having access to songs stored on the multiple devices 140. The song the user is searching for in particular may be on one of the multiple devices 140. Accordingly, the mobile device 102 can broadcast the song request to listening devices capable of interpreting and possible providing the song. In practice, the speech recognition systems may respond with one or more matches to the song request. The mobile device can present a list of songs from which the user can choose a song. The user can purchase the song using the device and download the song.

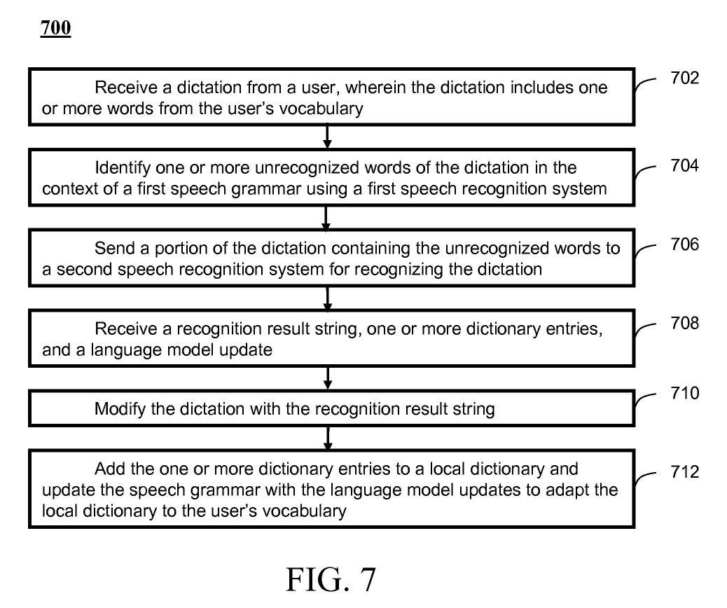

Referring to FIG. 7, a method of adapting a speech grammar for voice dictation is shown. Briefly, referring to FIG. 1, the mobile device 102 includes the dictation unit 212 for capturing and recording a user's voice. The mobile device can convert one or more spoken utterances to text.

At step 702, a dictation from a user can be received, wherein the dictation includes one or more words from the user's vocabulary. At step 704, one or more unrecognized words of the dictation can be identified. For example, the speech recognition system (202) may attempt to recognize the spoken utterance in the context of the speech grammar but may fail. In response to the failure, the mobile device (102) can send the spoken utterance to a server (130) for processing the spoken utterance.

At step 706, a portion of the dictation containing the unrecognized words can be sent to the speech recognition system (222) on the server (130) for recognizing the dictation. Upon correctly recognizing the spoken utterance, at step 708, the server (130) can send a recognition result string, one or more dictionary entries, and a language model update to the SRS (202) on the mobile device. The recognition result string can be a text of the recognized utterance, the one or more dictionary entries can be parameters associated with the recognized words, for example, transcriptions representing the pronunciation of those words.

At step 710, the mobile device 102 can modify the dictation upon receipt of the recognition result string and add the one or more dictionary entries to the local dictionary 210 and update the speech grammar 204 with the language model updates. For example, the dictation can be modified to include the correct recognition and the speech grammars can be updated to learn from the failed recognition attempt. Consequently, the SRS 202 adapts the local vocabulary and dictionary (210) to the user's vocabulary.

In one aspect, the dictation message, including the correct recognition, is displayed to the user for confirmation. For example, during dictation, one or more correct recognitions may be received from the server 130. The mobile device 102 displays the correct recognition while the user is dictating to inform the user of the corrections. The user can accept the corrections, upon which, the mobile device will update the speech grammars, the vocabulary, and the dictionary. A confirmation can be sent to the server informing the server of the accepted correction. The dictation message can be stored and referenced as a starting point for further dictations. The dictation messages can be ranked by frequency of use and presented to the user as a browsable list for display. The user can scroll through the browsable list of dictations and continue with the dictations or edit the dictations through speech recognition. For example, the mobile device displays the recognition result string for soliciting a confirmation, and upon receiving the confirmation, stores the recognition result into a browsable archive.

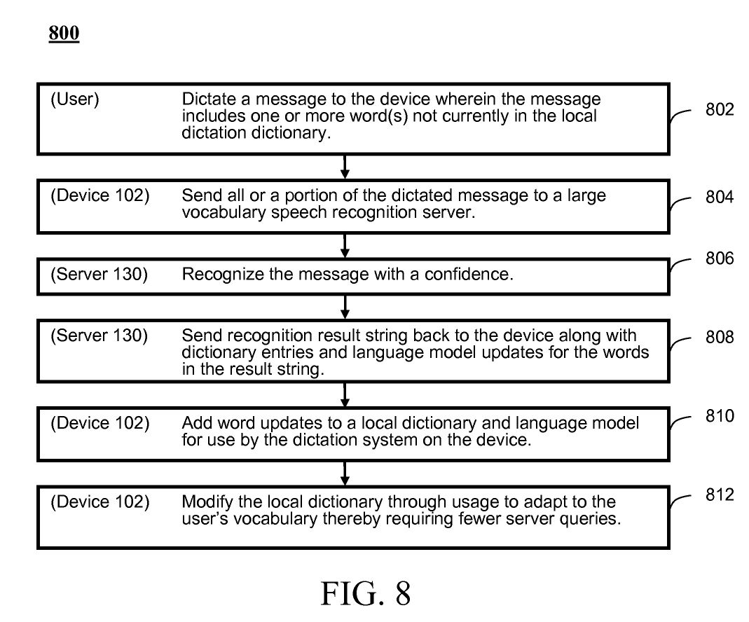

Referring to FIG. 8, a grammar adaptation for voice dictation is shown. At step 802, a user dictates a message to the device wherein the message includes one or more word(s) not currently in the local dictation dictionary. At step 804, the device sends all or a portion of the dictated message to a large vocabulary speech recognition server. At 806, the message is recognized on the server with a confidence. At step 808, a recognition result string is sent back to the device along with dictionary entries and language model updates for the words in the result string. At step 810, the device adds word updates to a local dictionary and language model for use by the dictation system on the device. This can include adding new vocabulary words and updating the speech grammar and the dictionary. At step 812, the device modifies the local dictionary through usage to adapt to the user's vocabulary thereby requiring fewer server queries.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A method for grammar adaptation, comprising:
selecting a first speech grammar for use in a first speech recognition system;
attempting a first recognition of a spoken utterance using the first speech grammar;
based on an unsuccessful recognition, consulting a second speech recognition system using a second speech grammar; and
sending a correct recognition result for the first recognition and a portion of a speech grammar from the second speech recognition system to the first speech recognition system for updating the first recognition system and the first speech grammar,
wherein the first speech recognition system adapts a recognition of one or more spoken utterances in view of the first recognition and the portion of a speech grammar provided by the second recognition system.

2. The method of claim 1, wherein the speech grammar can be a rule based grammar such as a context free grammar, or a non-rule based grammar such as a finite state grammar or a recursive transition network.

3. The method of claim 1, wherein the consulting further comprises:
acknowledging an unsuccessful recognition of the second speech recognition system for recognizing the spoken utterance;
informing the first speech recognition system of the failure;
receiving a manual text entry in response to the recognition failure for providing a correct recognition result of the first recognition; and
updating the first speech grammar based on the manual text entry.

4. The method of claim 1, wherein the consulting further comprises:
determining a recognition success at the second speech recognition system for recognizing the spoken utterance; and
informing the first speech recognition system of the recognition success through the correct recognition result and the portion of a speech grammar, wherein the correct recognition result includes one or more associated resources corresponding to a correct interpretation of the spoken utterance.

5. The method of claim 1, further comprising:
establishing a cooperative communication between the first speech recognition system and the second speech recognition system; and
synchronizing the first speech grammar with the second speech grammar for providing an application context of the spoken utterance based on a recognition failure, wherein the first speech recognition system and the second speech recognition system use grammars of the same semantic type for establishing the application context.

6. The method of claim 1, wherein the first speech recognition system updates an associated resource based on a receipt of the correct recognition result.

7. The method of claim 1, further comprising:
logging one or more recognition successes and one or more recognition failures for tuning the speech recognition system.

8. The method of claim 7, further comprising:
evaluating a usage history of correct recognition results in the dictionary; and
replacing a least frequently used recognition result with the correct recognition result.

9. The method of claim 7, wherein the resource is at least one of a dictionary, a dictation memory, a phonebook, a song list, a media play list, and a video play list.

10. The method of claim 7, further comprising adding a correct vocabulary to a recognition dictionary, wherein the dictionary contains one or more word entries corresponding to a correct interpretation of the spoken utterance.

11. The method of claim 10, further comprising:
receiving a request to download at least a portion of a grammar from a network onto the first speech recognition system.

12. A system for grammar adaptation, comprising:
a mobile device comprising:
a first speech grammar having a local dictionary;
a first speech recognition system for attempting a first recognition of a spoken utterance using said first speech grammar; and
a processor for sending the spoken utterance to a server in response to a recognition failure and for receiving a recognition result of the first recognition and at least a portion of a speech grammar from the server for updating the first recognition and the first speech grammar,
wherein the speech recognition system adapts the recognition of one or more spoken utterances in view of the recognition result and updated speech grammar.

13. The system of claim 12, wherein the mobile device further comprises:
a phone book for identifying one or more call resources and a vocabulary of a recognized call parameter and a call list update to the first speech grammar, wherein the spoken utterance identifies the call parameters.

14. The system of claim 12, further comprising
a speech server comprising:
a second speech grammar having access to a dictionary;
a second speech recognition system for using said second speech grammar to recognize the spoken utterance; and
a processor for sending a recognition result of the spoken utterance and a portion of a speech grammar employed to recognize the spoken utterance to the mobile device.

15. The system of claim 14, wherein the speech server sends a portion of a dictionary associated with the portion of the grammar and a portion of an application database associated with the portion of the grammar to the mobile device along with the portion of the speech grammar.

16. The system of claim 14, wherein the mobile device further comprises:
a communication unit for synchronizing the first speech grammar used by the first speech recognition system with the second speech grammar used by the second speech recognition system for providing an application context of the spoken utterance to the speech server based on a recognition failure.

17. The system of claim 12, wherein the mobile device further comprises:
a music player for receiving the vocabulary of a recognized song and a song list update to the first speech grammar, wherein the spoken utterance identifies a song.

18. The system of claim 17, wherein the mobile device broadcasts a song request to at least one listening device that interprets the spoken utterance and provides the recognized song to the mobile device for download.

19. The system of claim 12, wherein the mobile device further comprises:
a voice dictation unit for capturing speech, converting one or more spoken utterances to text, and receiving a vocabulary for updating the first speech grammar.

20. The system of claim 19, wherein the speech recognition system updates the local dictionary with the vocabulary, one or more dictionary entries, and a language model update.

21. A method of adapting a speech grammar for voice dictation, comprising:
receiving a dictation from a user, wherein the dictation includes one or more words from the user's vocabulary;
identifying one or more unrecognized words of the dictation in an application context of a first speech grammar using a first speech recognition system having a dictionary and a language model;
sending at least a portion of the dictation containing the unrecognized words to a second speech recognition system for recognizing the dictation;
receiving a recognition result string with one or more dictionary entries and a language model update for one or more words in the result string;
modifying the dictation with the recognition result string; and
adding the one or more words to the dictionary and the language model, wherein the dictionary is modified to adapt to the user's vocabulary.

22. The method of claim 21, further comprising using the dictation as a starting point for creating one or more messages, wherein the messages are ranked by a frequency of usage.

23. The method of claim 21, further comprising:
displaying the recognition result string for soliciting a confirmation.

24. The method of claim 23, further comprising storing the recognition result into a browsable archive.
